(19) United States
(12) Patent Application Publication
(10) Pub. No.: US 2022/0013130 A1
(43) Pub. Date: Jan. 13, 2022

(54) SHARED AI SPEAKER

(71) Applicant: EWBM Co., Ltd., Seongnam-si (KR)

(72) Inventor: Stephen Sang Geun OH, Seoul (KR)

(73) Assignee: EWBM Co., Ltd., Seongnam-si (KR)

(21) Appl. No.: 17/291,953

(22) PCT Filed: Dec. 3, 2019
(86) PCT No.: PCT/KR2019/016940

§ 371 Date: Sep. 30, 2021

(30) Foreign Application Priority Data
Dec. 4, 2018 (KR) 10-2018-0154772

(51) Int. Cl. G10L 17/22; G06F 21/32; G10L 15/22; G06T 7/20

(52) U.S. Cl. CPC G10L 17/22; G06F 21/32; G10L 2015/225; G06T 7/20; G10L 2015/223; G10L 15/22

(57) ABSTRACT

Disclosed is a shared AI speaker shared by a plurality of users, the shared AI speaker including: a connection unit to which a biometric FIDO authentication apparatus of each user registered in a relying party on a cloud connects; a user determination unit which attempts FIDO authentication to the relying party when biometric information of the user is input to one of the biometric FIDO authentication apparatus and is locally authenticated, and an authentication message is input to the connection unit, and determines a current user when receiving an authentication response; and a customized response unit which receives a voice command of the current user and determines and outputs a response according to a registered data of the determined current user.

### CROSS-REFERENCE TO RELATED APPLICATION

The present application is a U.S. National Phase entry of International Patent Application No. PCT/KR2019/016940, filed Dec. 3, 2019, which claims priority to Korean Patent Application No. 10-2018-0154772, filed Dec. 4, 2018, the entire contents of which are incorporated herein for all purposes by this reference.

### TECHNICAL FIELD

The present invention relates to a shared AI speaker used by a plurality of people together.

### BACKGROUND ART

In general, an AI speaker is known. The AI speaker is a system which understands a command of a user by using artificial intelligence, such as natural language processing, processes data by using big data, and the like, and outputs a response to the command of the user as a sound.

The AI speaker responds to the command of the user, but does not have an ability of discriminating a user. For example, whether a grandfather gives a command or a 6-year-old girl gives a command in a family, the AI speaker provides services regardless of the user. Accordingly, the AI speaker cannot provide any specialized service for each user among multiple users.

In the meantime, there is an attempt to discriminate users according to a person's voiceprint. However, up to the present, there is no practical excellent case.

The patent document below discloses an “artificial intelligence speaker of human interface processing-type based on communication continuity identification by eye recognition, including: a user hardware unit 210 including a microphone module 211 for receiving a user's voice signal, a speaker module 212 for outputting a sound to a user in providing services, and a camera module 213 for photographing the user; a wake-up word identifying unit 220 for identifying a predetermined wake-up word from the user's voice signal; an operation mode managing unit 230 for managing an idle mode and a request standby mode as operations modes of the artificial intelligence speaker, and setting the operation mode to the idle mode when the artificial intelligence speaker starts operating, for setting the operation mode to the request standby mode when the wake-up word is identified by the wake-up word identifying unit 220, and returning the operation mode from the request standby mode to the idle mode in response to a termination event of a predetermined request standby time; a request identifying unit 240 for natural language processing the user's voice signal input through the microphone module 211 while the operation mode is the request standby mode and identifying a request input to the artificial intelligence speaker by the user; a user eye identifying unit 250 for analyzing a user photographed image acquired through the camera module 213 while the operation mode is the request standby mode and identifying an eye maintenance event at which the user looks at the artificial intelligence speaker; a communication continuity identification processing unit 260 for controlling the operation mode managing unit 230 while the operation mode is the request standby mode and extending the request standby time when the eye maintenance event is identified through the user eye identifying unit 250; a request temporal buffer unit 270 for temporarily storing one or more past requests identified by the request identifying unit 240; and a service identification processing unit 280 for connecting and analyzing the contents of the current request identified by the request identifying unit 240 by referring to the one or more past requests temporarily stored in the request temporal buffer unit 270, identifying a service to be provided to the user in response to the current request, and implementing the identified service through the speaker module 212.”

### PRIOR ART LITERATURE

(Patent Document 1) Patent Application Laid-Open Gazette No. 10-2018-0116100.

### DISCLOSURE

### Technical Problem

However, in order for multiple users to share one AI speaker, it is necessary to distinguish which user's command is the sound data input at a certain moment. In the distinguishment of the user by voiceprint, the voiceprint has a lower SN ratio than that of ambient noise, so that the voiceprint cannot be used for practical purposes. The technology of the patent document above neither discloses nor suggests technology for sharing AI speaker among multiple users.

The present invention is for the purpose of solving the problems in the related art, and provides a shared AI speaker which is capable of clearly distinguishing a commander among multiple users at one moment even when multiple users share one AI speaker.

Further, the present invention provides a shared AI speaker which is capable of verifying which commander is a registered user having approval of usage.

### Technical Solution

The present invention for achieving the object above provides a shared AI speaker shared by a plurality of users, including: a connection unit to which a biometric FIDO authentication apparatus of each user registered in a relying party on a cloud is connected; a user determination unit which attempts FIDO authentication to the relying party when biometric information of the user is input to one of the biometric FIDO authentication apparatus and is locally authenticated, and an authentication message is input to the connection unit, and determines a current user when receiving an authentication response; and a customized response unit which receives a voice command of the current user and determines and outputs a response according to a registered data of the determined current user.

Further, a predetermined amount of the registered data of the user may be temporarily stored in a memory of the shared AI Speaker for each user, and when the current user is determined, the temporarily stored data may be used prior to data transmitted from a server.

Further, the shared AI speaker may further include a camera or a capacitive sensor assembly formed by collecting multiple capacitive sensors acquiring a motion image of each user.

Further, when biometric information of two or more users is simultaneously input to the biometric FIDO authentication apparatus, the user determination unit may be controlled to transmit a re-input demanding message.

### Advantageous Effects

According to the present invention, the present invention can provide the shared AI speaker which is capable of clearly distinguishing a commander among multiple users at one moment even though when multiple users share one AI speaker.

Further, the present invention provides the shared AI speaker which is capable of verifying whether a commander is a registered user who is approved of use.

### DESCRIPTION OF DRAWINGS

FIG. 1 is a system block diagram illustrating an example of a shared AI speaker according to an exemplary embodiment of the present invention, and illustrates an example of a situation where multiple users use one AI speaker.

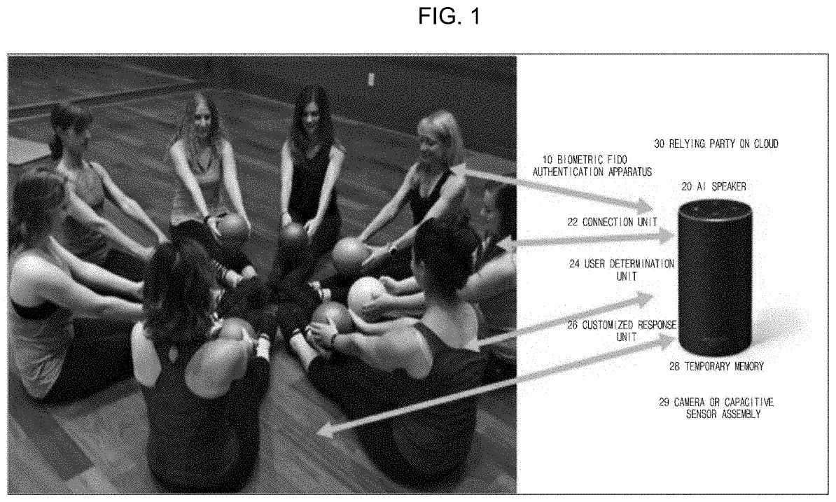

### BEST MODE

Hereinafter, an exemplary embodiment of the present disclosure will be described in detail with reference to the accompanying drawings. The advantages and characteristics of the present invention, and a method for achieving the advantages and characteristics will become clear by referring to the exemplary embodiment, which is described in detail, together with the accompanying drawings. However, the present disclosure is not limited to exemplary embodiments disclosed herein but will be implemented in various forms, and the exemplary embodiments are provided so that the present disclosure is completely disclosed, and a person of ordinary skilled in the art can fully understand the scope of the present disclosure, and the present disclosure will be defined only by the scope of the appended claims. Throughout the specification, the same reference numeral indicates the same constituent element.

Unless otherwise defined, all of the terms (including technical and scientific terms) used in the present specification may be used as a meaning commonly understandable by those skilled in the art. Further, terms defined in a generally used dictionary shall not be construed as being ideal or excessive in meaning unless they are clearly defined.

Further, the connection of a specific member or module to the front, rear, left, right, top, or bottom of another member or module may include not only a direct connection, but also a case where the specific member or module is connected to the front, rear, left, right, top, or bottom of another member or module with another third member or module interposed therebetween. Further, a member or module performing a specific function may be divided into and implemented with two or more members or modules by dividing the function, and on the contrary, two or more members or modules each having a function may be combined and implemented as one member or module by combining the functions. Further, a specific electronic functional block may be implemented by execution of software, and may also be implemented in the form in which the software is implemented in hardware through an electric circuit.

<Basic Configuration>

An AI speaker 20 of the present invention is a shared AI speaker shared by multiple users.

The shared AI speaker 20 is characterized in that the shared AI speaker 20 includes a connection unit 22, a user determination unit 24, and a customized reaction unit 26.

The connection unit 22 is an interface configuration unit to which a biometric FIDO authentication apparatus 10 of each user registered in a relying party 30 on the Cloud is connected. The connection unit 22 is an interface configured to send and receive data with the biometric FIDO authentication apparatus 10. The connection between both the connection unit 22 and the biometric FIDO authentication apparatus 10 may be formed in, for example, a USB interface, or a Bluetooth interface, and any other wired/wireless interface may belong to the scope of the present invention. Original biometric information of each users is registered in corresponding the biometric FIDO authentication apparatus 10. The connection unit 22 may be configured not to be provided at the AI speaker 20, but to be provided at an independent device, such as a user's terminal.

The user determination unit 24 is the means for determining a current user by FIDO authentication in order to determine a user of an input user's voice command. To this end, instaneous biometric information of the user is input to one of the biometric FIDO authentication apparatus 10 and is compared to the original biometric information. When they are judged as same, the instaneous biometric information is locally authenticated. By which an authentication message is input to the connection unit 22 and the connection unit 22 attempts an FIDO authentication with the relying party 30. When the AI speaker 20 receives an authentication response, the user determination unit 24 determines the user as a current user.

The customized response unit 26 is the means for receiving a voice command of the current user and determining and outputting a response according to a registered data of the determined current user. For example, even in the case where eight users use one AI speaker together, it is necessary to determine only one user who needs voice command to be recognized by the AI speaker at any one moment. And, when one user is determined, it is desirable to clarify true meaning of the current voice command, and determining and outputting an appropriate response by referring to an age, gender, frequency of use, past conversation history, and the like of the user.

By the foregoing configuration, in the case where multiple users share one AI speaker, it is possible to appropriately output a response based on past data of a user for a voice command of the one user.

<Temporary Memory>

In this case, a temporary memory 28 is further provided, so that a predetermined amount of registered data of the user is temporarily stored in the memory 28 of the shared AI speaker for each user. And when the current user is determined, it is desirable that the temporarily stored data are used prior to the data transmitted from a server.

The temporary memory 28 may serve function as a buffer, and the AI speaker autonomously retrieves past data of the user without the need to access the data in the server for AI processing of the current multiple users and immediately performing a response that fits the tendency of the user.

<Operation Recognition Configuration>

In the meantime, it is desirable that a camera or a capacitive sensor assembly 29 formed by collecting a plurality of capacitive sensors acquiring a motion image of each user is further provided. The capacitive sensor assembly is a means in which a plurality of capacitive sensor whose detection values vary according to the strength and change of the capacitance are disposed in the form of multiple arrays to recognize a motion of a person from a change in capacitance by, for example, body moisture and weak current of the person.

The camera or capacitive sensor assembly may track motions of the multiple users. Accordingly, for example, when multiple users do gymnastics or yoga, and a motion of a specific user is wrong comparing to a motion of normal time, the AI speaker may determine that the motion of the specific user is out of a pattern and output a warning message or a comment requiring correction.

<Handling Competition of Multiple Users>

When biometric information of two or more users is simultaneously input to the biometric FIDO authentication apparatus 10, the user determination unit 24 is controlled to transmit a re-input demanding message.

Accordingly, when a competition occurs, the present invention gives an opportunity to set an arranged order between multiple users in order to clearly determine a current user.

While the exemplary embodiment of the present invention has been shown and described with reference to the accompanying drawings, and it will be understood by those skilled in the art that the present invention may be made in other specific forms without the change of the technical spirit or the essential features of the present invention. Therefore, it should be understood that the aforementioned exemplary embodiments are all illustrative and are not limited.

[Industrial Applicability]

The present invention is usable in a shared AI speaker industry.

<Explanation of Reference Numerals and Symbols>

10: Biometric FIDO authentication apparatus

20: AI speaker

22: Connection unit

24: User determination unit

26: Customized response unit

28: Temporary memory

29: Camera or capacitive sensor assembly

30: Relying party on Cloud

1. A shared AI speaker shared by multiple users, comprising:
a connection unit to which a biometric FIDO authentication apparatus of each user registered in a relying party on a cloud is connected;
a user determination unit which attempts FIDO authentication to the relying party when biometric information of the user is input to one of the biometric FIDO authentication apparatus and is locally authenticated, and an authentication message is input to the connection unit, and determines a current user when receiving an authentication response; and
a customized response unit which receives a voice command of the current user and determines and outputs a response according to a registered data of the determined current user.

2. The shared AI speaker of claim 1, wherein a predetermined amount of the registered data of the user is temporarily stored in a memory of the shared AI Speaker for each user, and
when the current user is determined, the temporarily stored data are used prior to data transmitted from a server.

3. The shared AI speaker of claim 1, further comprising:
a camera or a capacitive sensor assembly formed by collecting multiple capacitive sensors acquiring a motion image of each user.

4. The shared AI speaker of claim 1, wherein when biometric information of two or more users is simultaneously input to the biometric FIDO authentication apparatus, the user determination unit is controlled to transmit a re-input demanding message.
